(19) United States
(12) Patent Application Publication
(10) Pub. No.: US 2008/0279169 A1
(43) Pub. Date: Nov. 13, 2008

(54) Methods and Apparatuses for Intrasystem and Intersystem Sliding Intermediate Frequency Transception

(75) Inventor: Yifeng Zhang, San Jose, CA (US)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: KONINKLIJKE PHILIPS ELECTRONICS N.V., Eindhoven (NL)

(21) Appl. No.: 11/574,240

(22) PCT Filed: Aug. 26, 2005
(86) PCT No.: PCT/IB2005/052807

§ 371 Date: Jan. 18, 2008

Related U.S. Application Data
(60) Provisional application No. 60/605,114, filed on Aug. 27, 2004.

(51) Int. Cl. H04J 1/00

(52) U.S. Cl. 370/343

(57) ABSTRACT

Systems and methods according to the present invention provide methods for wireless communications and devices associated therewith which vary the intermediate frequency based upon the particular channel and/or system with which a wireless station is communicating. Tailoring the selection of an intermediate frequency in this way, enables signal energy associated with images created by heterodyne processing to be more easily removed.

The present invention relates generally to wireless communication systems and, more particularly, to IEEE 802.11a/b/g Wireless Local Area Network (WLAN) systems.

Technologies associated with the communication of information have evolved rapidly over the last several decades. For example, over the last two decades wireless communication technologies have transitioned from providing products that were originally viewed as novelty items to providing products which are the fundamental means for mobile communications. Perhaps the most influential of these wireless technologies were cellular telephone systems and products. Cellular technologies emerged to provide a mobile extension to existing wireline communication systems, providing users with ubiquitous coverage using traditional circuit-switched radio paths. More recently, however, wireless communication technologies have begun to replace wireline connections in almost every area of communications. WLANs are rapidly becoming a popular alternative to the conventional wired networks in both homes and offices.

Many of today's WLAN systems operate in accordance with the IEEE 802.11b standard. As will be appreciated by those skilled in the art, IEEE 802.11 specifies that WLAN devices will use one of two spread spectrum access methodologies, specifically either frequency-hopping or code spreading. In frequency hopping systems, a wireless connection between two WLAN units will periodically change frequencies according to a predefined hop sequence. In code spreading (also sometimes referred to as “direct sequence spreading”), the wireless data signal is spread across a relatively wideband channel by, for example, multiplication with a pseudorandom noise (PN) sequence. Other WLANs are designed in accordance with the IEEE 802.11a or 802.11g standards. These standards provide for the transmission of signals using orthogonal frequency division multiplexing (OFDM). In OFDM systems, a signal is split into several narrowband channels each of which is transmitted at a different frequency. At the receiving side, the narrowband channels are recovered using, e.g., a homodyne or heterodyne receiver, and then the desired signal is recreated by combining data from the various narrowband channels.

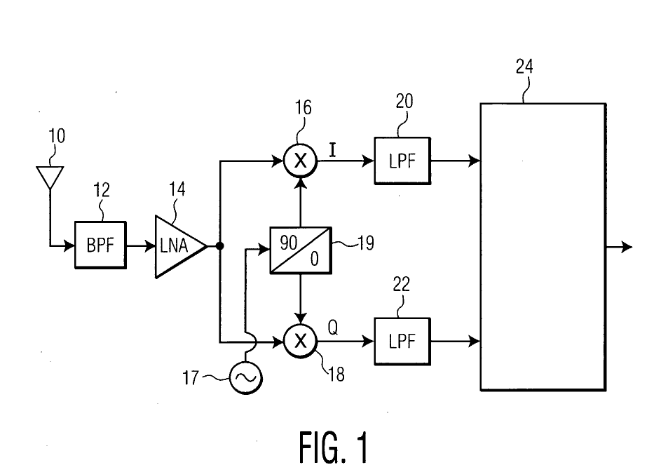

A homodyne receiver, also known as a direct conversion or zero-IF receiver, takes a received signal and converts it directly from its radio carrier frequency to a baseband frequency at which it can be operated on by a processor to decode its payload information. An example of a homodyne receiver is shown in FIG. 1. Therein, a signal is received via antenna 10, filtered to obtain only the band of interest using, e.g., a bandpass filter 12 and amplified by, e.g., a low noise amplifier (LNA) 14. The amplified signal is downconverted in mixers 16 and 18 to the baseband frequency using local oscillator 17 and phase shifter 19 to generate I and Q signals. The I and Q signals may then be low pass filtered, if necessary, to extract the desired narrowband channel(s) by LPFs 20 and 22. The resulting baseband signals are then further processed to decode the information received therein as indicated by unit 24. Homodyne receivers, however, suffer from DC offset and I/Q imbalance issues.

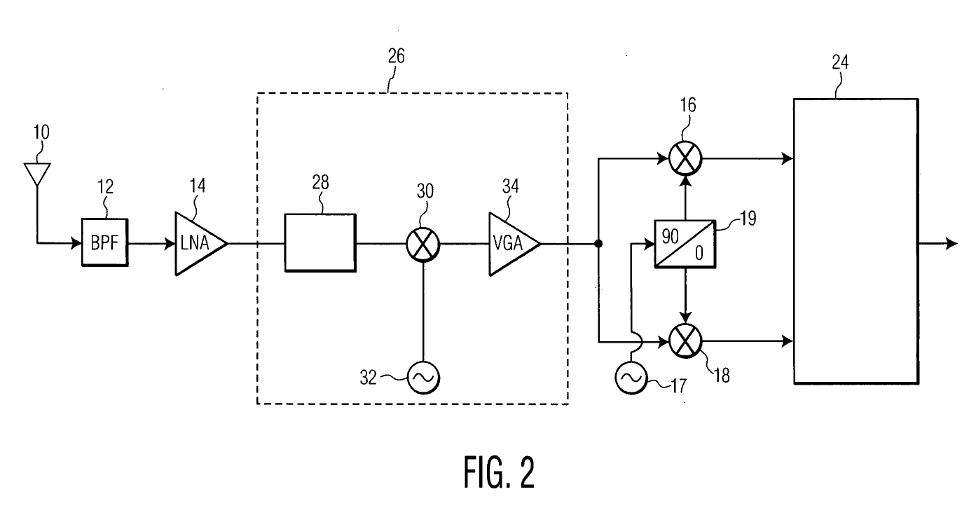

A heterodyne receiver, on the other hand, first converts the radio carrier frequency to an intermediate frequency (IF) prior to converting that signal to baseband. An example of a heterodyne receiver is shown in FIG. 2, wherein similar elements to those found in the homodyne receiver of FIG. 1 are referenced using the same reference numerals and function in a similar manner as described above. It can be seen that the heterodyne receiver has an extra section 26 relative to the homodyne receiver of FIG. 1. An image rejection filter 28 rejects the image band associated with the RF signal. The mixer 30 downconverts the radio frequency signal to an intermediate frequency (IF) signal using its clock source/local oscillator 32. The resultant IF signal may then be amplified using, e.g., variable gain amplifier (VGA) 34 and the IF signal translated to baseband in a similar manner to that described above with respect to the homodyne receiver of FIG. 1. Various heterodyne designs can be used, e.g., receivers having a relatively low-IF or receivers having a relatively high-IF. High-IF receivers suffer from high costs associated with the bulky surface acoustic wave (SAW) filter used as image rejection filter 28. Low-IF receivers have very stringent requirements for image rejection in 802.11a/b/g systems.

Accordingly, it would be desirable to provide techniques and devices for providing transceivers which avoid the problems of conventional techniques.

Systems and methods according to the present invention address this need and others by providing methods for wireless communications and devices associated therewith which vary the intermediate frequency based upon the particular channel and/or system with which a wireless station is communicating. Tailoring the selection of an intermediate frequency in this way, enables signal energy associated with images created by heterodyne processing to be more easily removed.

According to one exemplary embodiment of the present invention, a method for wireless communication includes the steps of a method for wireless communication includes the steps of selecting one of a plurality of predetermined intermediate frequencies based on a channel to be used for communication, receiving a signal on the channel, downconverting the signal using the selected one of the plurality of predetermined intermediate frequencies to generate a downconverted signal; and demodulating the downconverted signal.

According to another exemplary embodiment of the present invention, a receiver includes an antenna for receiving a signal, at least one mixer for downconverting the signal using one of a plurality of different intermediate frequencies, wherein the one of the plurality of different intermediate frequencies is selected based upon a channel on which the signal is received; and a processor for processing the downconverted signal to generate output data.

The accompanying drawings illustrate exemplary embodiments of the present invention, wherein:

FIG. 1 depicts an exemplary homodyne receiver architecture;

FIG. 2 depicts an exemplary heterodyne receiver architecture;

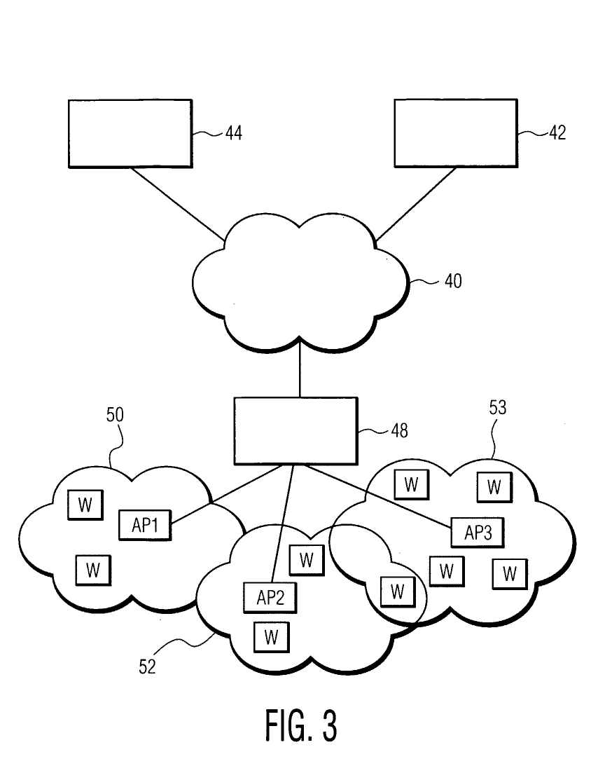

FIG. 3 illustrates an exemplary WLAN system in which the present invention can be implemented;

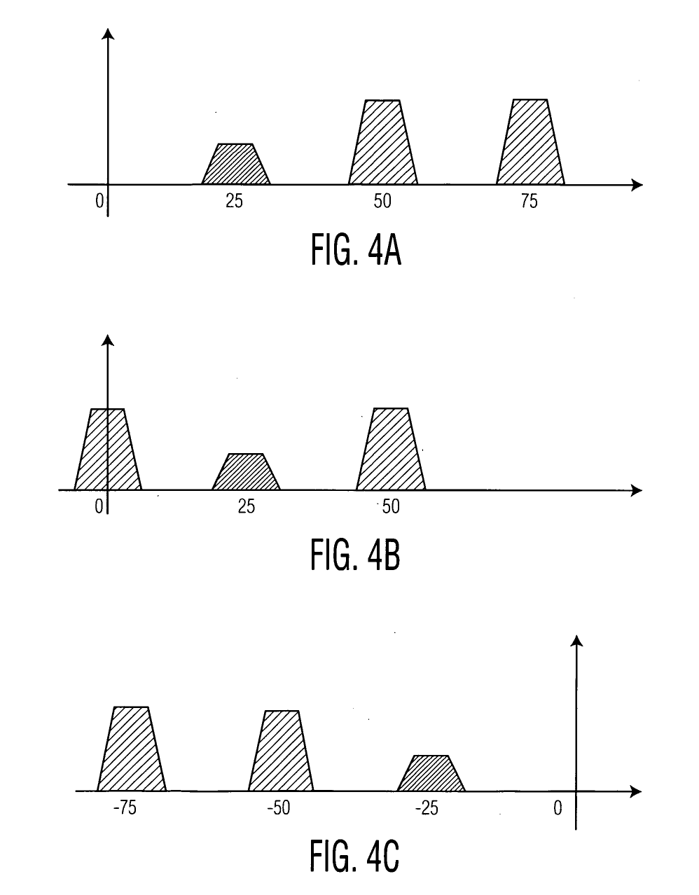

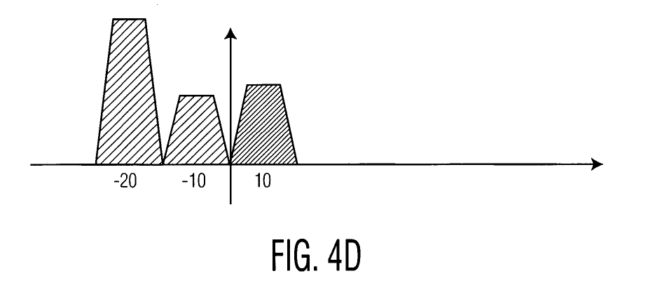

FIGS. 4(a)-4(d) depict signal processing using selected intermediate frequencies according to an exemplary embodiment of the present invention;

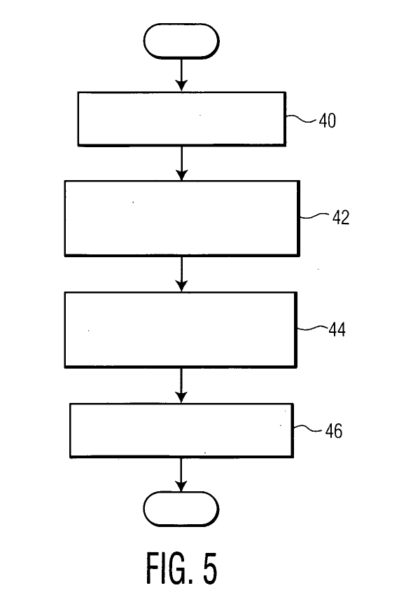

FIG. 5 is a flowchart depicting an exemplary method for wireless communication according to an exemplary embodiment of the present invention; and

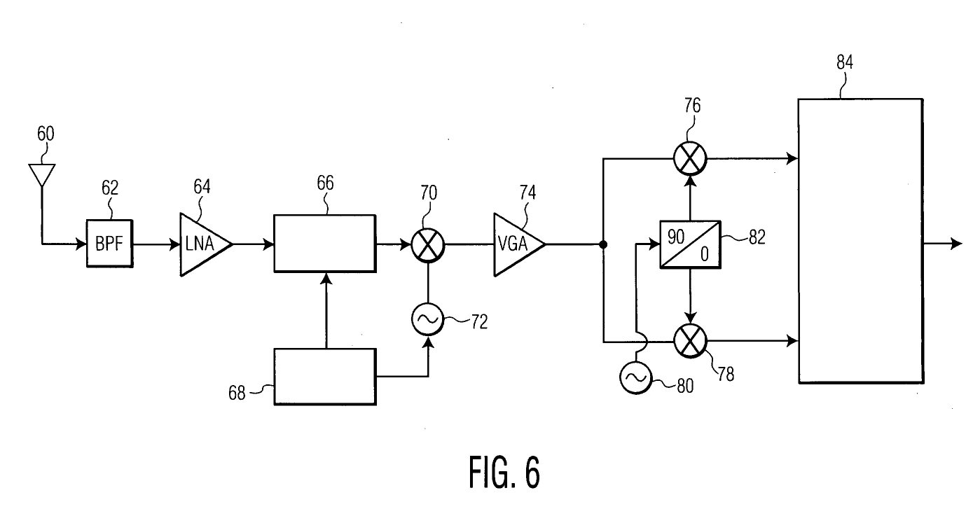

FIG. 6 shows an exemplary receiver architecture according to an exemplary embodiment of the present invention.

The following detailed description of the invention refers to the accompanying drawings. The same reference numbers in different drawings identify the same or similar elements. Also, the following detailed description does not limit the invention. Instead, the scope of the invention is defined by the appended claims.

In order to provide some context for this discussion, an exemplary WLAN system will first be described with respect to FIG. 3. Those skilled in the art will appreciate, however, that the present invention is not restricted to implementation in WLAN systems. Therein, a wireline network 40 (e.g., an Ethernet network) has a file server 42 and workstation 44 connected thereto. Those skilled in the art will appreciate that typical wireline networks will serve numerous fixed workstations 44, however only one is depicted in FIG. 3 for simplicity. The wireline network 40 is also connected to a WLAN 46 via router 48. The router 48 interconnects the access points (AP) of the WLAN 46 with the wireline network, through which the access points can, for example, communicate with the file server 42. In the exemplary WLAN system of FIG. 1, three cells 50, 52 and 53 (also sometimes referred to as a Basic Service Set (BSS) or Basic Service Area (BSA) are shown each with a respective AP, although those skilled in the art will once again appreciate that more or fewer cells may be provided in WLAN 46. Within each cell, a respective AP serves a number of wireless stations (W) via a wireless connection.

According to exemplary embodiments of the present invention, the transmission of signals between APs and respective wireless stations W is performed using OFDM signals, e.g., in accordance with IEEE 802.11a or 802.11b/g. In particular, it is desirable to provide transceivers which are, on the one hand, able to communicate using either the IEEE 802.11b/g (2.4 GHz band) or IEEE 802.11a (5.0 GHz band), and, on the other hand, are able to use a low-IF heterodyne structure and handle the stringent image rejection requirements. Devices and methods according to exemplary embodiments of the present invention provide techniques for receiving such OFDM signals using a variable intermediate frequency which has the effect of transforming the image rejection issue into an adjacent channel interference issue. The design of bandpass filters to reduce adjacent channel interference involves significantly less complexity than the design of SAW filters for image rejection and, therefore, results in a cost-efficient transceiver design able to operate in either the 802.11a or 802.11b/g frequency band.

Consider FIGS. 4(a)-4(d) which depict the resulting frequency domain signals after selection and use of a particular IF based upon the particular system and/or channel which is being used to communicate with a wireless station W. In FIG. 4(a), channel 1 in an 802.11b/g system (2.4 GHz band) is being used for communication with a wireless station W. According to an exemplary embodiment of the present invention, the wireless station W selects an IF of 25 MHz for this system/channel communication. An exemplary technique for selecting a particular IF for use in a heterodyne receiver is described in more detail below. In FIG. 4(a), the desired signal (channel 1) is shown at an offset of 25 MHz from the local oscillator (LO) frequency, while the other two channels in the 802.11b/g system are shown at 50 and 75 MHz offset, respectively. For this case, the image associated with channel 1 is located at 2387 MHz in FIG. 4(a), which portion of the spectrum is not currently in use. This, in turn, means that the signal energy associated with the image is not very strong and can be suppressed by an image rejection filter (for example, polyphase filter, etc). Alternatively, 2.4 GHz inband interference rejection can be achieved by filtering instead of using image rejection techniques.

Referring now to FIG. 4(b), the wireless station W will also select an IF of 25 MHz if channel 6 is used in an 802.11b/g system for communication. Again, the selection of this IF results in the image signal energy being shifted into a portion of the spectrum which is defined as unusable for transmissions and which can be readily suppressed by a relaxed image rejection filter. If, however, channel 11 of an 802.11b/g system is to be used for communication with the wireless station W, then the wireless station W selects −25 MHz as the IF for use in downconverting the signal. This selection of a different IF for channel 11 results in the downconverted frequency spectra illustrated in FIG. 4(c). Therein, the desired signal at channel 11 is centered at the IF of −25 MHz, while channels 1 and 6 have signal energy at −75 and −50 MHz, respectively. In this case, by selecting an appropriate IF, the signal energy associated with the image of channel 11 is shifted to the right of LO frequency to again fall into a frequency region in which desirable transmit signal energy is not very strong, thereby enabling its removal using an image rejection structure.

If, however, the wireless station W is to communicate with an 802.11a (5 GHz) system, then it will use a third IF as shown in FIG. 4(d). Specifically, according to this exemplary embodiment of the present invention, the wireless station selects an IF of 10 MHz. In this case, the image signal is located at −10 MHz offset from LO frequency. However, the selection of an IF of 10 MHz, rather than the 25 or −25 MHz used for communication with an 802.11b/g system, results in relaxed image rejection requirements because the adjacent channel rejection requirement of an 802.11a system is quite relaxed, and a 35 dB image rejection is sufficient to fulfill the performance requirement.

Based on the foregoing, a general method for wireless communication according to an exemplary embodiment of the present invention is shown in the flowchart of FIG. 5. Therein, at step 40, the wireless station determines which channel (and system) it will be using to establish communications. This can be accomplished in a number of different ways. For example, the wireless station W can listen to the systems which are available in its current location and select from among those systems. Alternatively, the wireless station W can be preprogrammed to select a particular system and channel. Yet another technique would involve the system transmitting a channel assignment to the wireless station.

Regardless of how channel/system assignment occurs, the wireless station W uses the particular channel and/or system to determine the IF which it will use for communicating therewith. As described above, according to one exemplary embodiment of the present invention, the wireless station W will select from among three different IFs, e.g., 25 MHz, −25 MHz and 10 MHz, depending upon whether the channel identified for communication is, e.g., channel 1-6 in the 2.4 GHz band, channel 7-11 in the 2.4 GHz band or any channel in the 5 GHz band, respectively, at step 42. Then, the receiver will downconvert the received RF signal using the selected IF at step 44 and demodulate/decode the downconverted signal at step 46.

Various receiver architectures can be used to implement the present invention. A generalized sliding IF receiver structure according to an exemplary embodiment of the present invention is illustrated in FIG. 6. Therein, an antenna 60 receives a signal which is filtered to the desired band by bandpass filter 62 and amplified by LNA 64. A filter 66, in this example a polyphase filter having a variable center frequency, performs filtering or image rejection on the incoming signal. The center frequency of the filter 66 is controlled by processor 68 based on the channel which is currently intended for reception. The center frequency of the polyphase filter 66 can be adjusted by resistor switching of resistors (not shown) in the gyrator circuitry of the polyphase filter 66. The mixer 70 downconverts the radio frequency signal to one of, for example, three different intermediate frequencies as described above with respect to FIGS. 4(a)-4(d). The selection of a particular IF is made by processor 68 based on the current channel and/or system being used for communication in conjunction with, e.g., programmable LO 72. The resultant IF signal may then be amplified using, e.g., variable gain amplifier (VGA) 74 and the IF signal translated to baseband via elements 76-84.

The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

1. A method for wireless communication comprising the steps of: selecting one of a plurality of predetermined intermediate frequencies based on a channel to be used for communication; receiving a signal on said channel; downconverting said signal using said selected one of said plurality of predetermined intermediate frequencies to generate a downconverted signal; and demodulating said downconverted signal.

2. The method of claim 1, wherein said signal is one of an orthogonal frequency division multiplexed (OFDM) signal and a complementary code keying (CCK) signal.

3. The method of claim 1, wherein said step of selecting further comprises the step of: selecting a first intermediate frequency if said channel is within a first range of channels and selecting a second intermediate frequency if said channel is within a second range of channels.

4. The method of claim 3, wherein said communication occurs in a 802.11b/g system, said first range of channels is channels 1-6, said second range of channels is channels 7-11, said first intermediate frequency is +25 MHz and said second intermediate frequency is −25 MHz.

5. The method of claim 3, wherein said communication occurs in one of an 802.11b/g system, and an 802.11a system, said first range of channels are channels 1-11 in said 802.11b/g system, said second range of channels include all channels within said 802.11a system, said first intermediate frequency is +/−25 MHz and said second intermediate frequency is 10 MHz.

6. A receiver comprising: an antenna for receiving a signal; at least one mixer for downconverting said signal using of a plurality of different intermediate frequencies, wherein said one of said plurality of different intermediate frequencies is selected based upon a channel on which said signal is received; and a processor (68) for processing said downconverted signal to generate output data.

7. The receiver of claim 6, wherein said signal is one of an orthogonal frequency division multiplexed (OFDM) signal and a complementary code keying (CCK) signal.

8. The receiver of claim 6, wherein said processor selects said intermediate frequency by selecting a first intermediate frequency if said channel is within a first range of channels and selecting a second intermediate frequency if said channel is within a second range of channels.

9. The receiver of claim 8, wherein said signal is received in an 802.11b/g system, said first range of channels is channels 1-6, said second range of channels is channels 7-11, said first intermediate frequency is +25 MHz and said second intermediate frequency is −25 MHz.

10. The receiver of claim 8, wherein said signal is transmitted in one of an 802.11b/g system and an 802.11a system, said first range of channels are channels 1-11 in said 802.11b/g system, said second range of channels include all channels within said 802.11a system, said first intermediate frequency is +/−25 MHz and said second intermediate frequency is 10 MHz.

11. The receiver of claim 6, further comprising a filter having a variable center frequency for filtering said received signal prior to said mixer downconverting said signal.

12. The receiver of claim 11, wherein said processor selects said variable center frequency based upon said channel on which said signal is received.
